(19) United States
(12) Patent Application Publication
(10) Pub. No.: US 2022/0166164 A1
(43) Pub. Date: May 26, 2022

(54) CONNECTOR

(71) Applicant: YAZAKI CORPORATION, Tokyo (JP)

(72) Inventors: Motonori Miyanari, Makinohara-shi (JP); Yoshimi Wada, Makinohara-shi (JP)

(21) Appl. No.: 17/535,156

(22) Filed: Nov. 24, 2021

(30) Foreign Application Priority Data
Nov. 25, 2020 (JP) 2020-195238

(51) Int. Cl. H01R 13/627; H01R 13/639; H01R 13/641; H01R 13/504; H01R 13/629; H01R 9/05

(52) U.S. Cl. CPC H01R 13/6272; H01R 13/639; H01R 9/05; H01R 13/5045; H01R 13/629; H01R 13/641

(57) ABSTRACT

A connector includes a housing having a lock portion to be engaged with a mating housing when the housing is fitted with the mating housing, and a fitting-ensuring component mounted on the housing and configured to detect whether the housing and the mating housing are fitted with each other by avoiding interference with the lock portion and being movable to a predetermined mounting position when the housing and the mating housing are fitted with each other. The lock portion and the fitting-ensuring component are configured that at least a part of one of the lock portion and the fitting-ensuring component enters a recess of the other of the lock portion and the fitting-ensuring component so as to extend a movable range of the lock portion when the lock portion is operated so as to release engagement between the lock portion and the mating housing.

### CROSS-REFERENCE TO RELATED APPLICATIONS

This application is based on and claims priority under 35 USC 119 from Japanese Patent Application No. 2020-195238 filed on Nov. 25, 2020, the contents of which are incorporated herein by reference.

### TECHNICAL FIELD

The present disclosure relates to a connector including a fitting-ensuring component (so-called Connector Position Assurance (CPA)).

### BACKGROUND ART

The related art has proposed a connector including a function of detecting whether a housing and a mating housing are in a properly fitted state (hereinafter, also referred to as “completely fitted state”) by using a fitting-ensuring component (CPA) (for example, see JP-A-2016-213080).

The fitting-ensuring component is generally used in a housing including a lock arm that can switch between maintaining and releasing the completely fitted state described above. Specifically, the lock arm and the fitting-ensuring component are configured such that interference between the fitting-ensuring component and the lock arm is avoided only in the completely fitted state and the fitting-ensuring component is mounted on a predetermined mounting position. In other words, when the housing and the mating housing are not in the completely fitted state, the fitting-ensuring component interferes with the lock arm and is not mounted on the mounting position. That is, it is possible to detect whether the housing and the mating housing are in the completely fitted state based on whether the fitting-ensuring component can be mounted on such a mounting position.

Incidentally, in the related-art connector described above, when separating the related-art housing in the completely fitted state from the mating housing for a reason such as maintenance, the housing is separated from the mating housing while deflecting the lock arm toward a lock release side. Therefore, in order to enable such deflection deformation of the lock arm, a space (so-called deflection space) corresponding to a deflection amount necessary for lock release is provided between the lock arm and the fitting-ensuring component. Further, the fitting-ensuring component has a thickness for ensuring strength and the like necessary for a function. As a result, in the related-art connector, a region corresponding to a total of a height of the deflection space and a thickness of the fitting-ensuring component is occupied for a fitting release operation. In other words, the related-art connector tends to be larger than a connector that does not have such a function by an amount necessary to exert the fitting detection function.

### SUMMARY OF INVENTION

The present invention has been made in view of the above-described circumstances, and an object thereof is to provide a connector that can be miniaturized while maintaining a function as a connector with a fitting-ensuring component (CPA).

In order to achieve the above-described object, there is provided a connector including:

a housing having a lock portion configured to be engaged with a mating housing when the housing is fitted with the mating housing; and

a fitting-ensuring component mounted on the housing and configured to detect whether the housing and the mating housing are fitted with each other by avoiding interference with the lock portion and being movable to a predetermined mounting position when the housing and the mating housing are fitted with each other,

in which the lock portion and the fitting-ensuring component are configured that at least a part of one of the lock portion and the fitting-ensuring component enters a recess of the other of the lock portion and the fitting-ensuring component so as to extend a movable range of the lock portion when the lock portion is operated so as to release engagement between the lock portion and the mating housing.

According to the present disclosure, it is possible to provide a connector that can be miniaturized as compared with a related-art connector while maintaining a function as a connector with a fitting-ensuring component (CPA).

The present disclosure has been briefly described above. Further, details of the present disclosure are further clarified by reading a mode for carrying out the disclosure (hereinafter, referred to as “embodiment”) described below with reference to the attached drawings.

### BRIEF DESCRIPTION OF DRAWINGS

Exemplary embodiments of the present disclosure will be described in detail based on the following figures.

FIG. 1 is a perspective view of a connector according to an embodiment of the present disclosure connected to a coaxial cable.

FIG. 2 is an exploded perspective view of the connector shown in FIG. 1.

FIG. 3 is a perspective view of a mating connector mounted on a circuit board.

FIGS. 4A and 4B are cross-sectional views corresponding to cross sections taken along lines A-A of FIGS. 1 and 3. FIG. 4A shows a state where the connector and the mating connector are in a fitting start state and a fitting-ensuring component (CPA) is in an initial position. FIG. 4B shows a state where the connector and the mating connector are in a completely fitted state and the fitting-ensuring component (CPA) is in a fitting-ensuring position.

FIG. 5A is a cross-sectional view corresponding to the cross sections taken along lines A-A of FIGS. 1 and 3, showing a state where the connector and the mating connector are in the completely fitted state, the fitting-ensuring component is in the initial position, and an operation portion of the lock portion is pushed downward. FIG. 5B is an enlarged view of a location surrounded by a rectangular frame of FIG. 5A.

FIG. 6A is a diagram corresponding to FIG. 1 of a connector according to a modification. FIG. 6B is a diagram corresponding to FIG. 5B of the modification shown in FIG. 6A.

FIG. 7A is a cross-sectional view corresponding to FIG. 5A of a connector according to further modification. FIG. 7B is an enlarged view of a location surrounded by a rectangular frame of FIG. 7A.

### DESCRIPTION OF EMBODIMENTS

### Embodiment

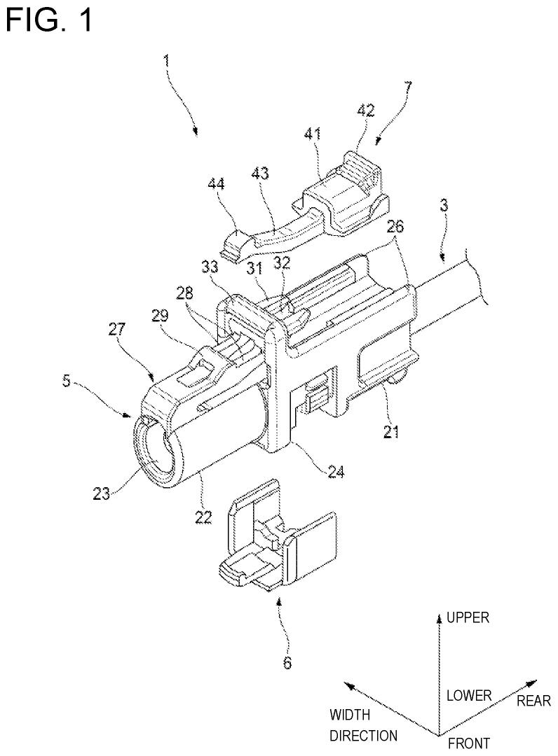

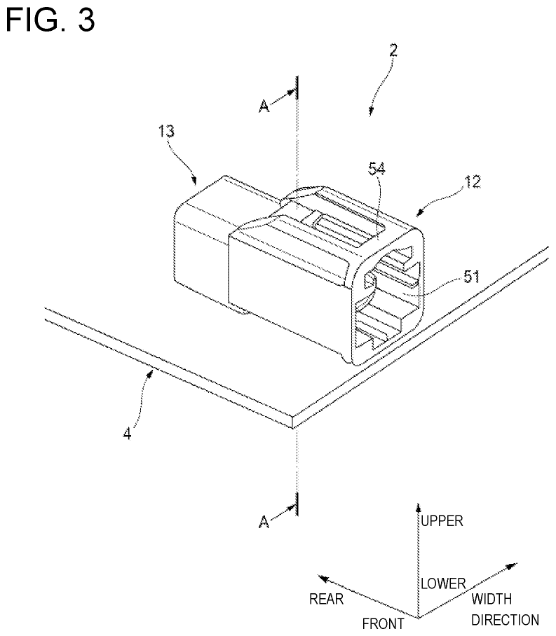

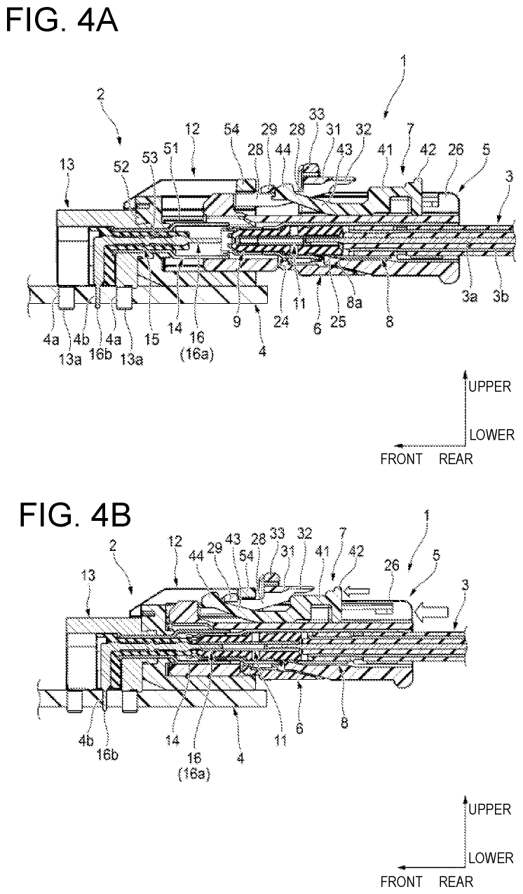

Hereinafter, a connector 1 according to an embodiment of the present disclosure will be described with reference to the drawings. As shown in FIGS. 4A and 4B, a female housing 5 of the connector 1 (see FIG. 1) can be fitted to a male housing 12 of a mating connector 2 (see FIG. 3). The female housing 5 corresponds to a “housing” in the present disclosure, and the male housing 12 corresponds to a “mating housing” in the present disclosure.

The connector 1 (see FIG. 1) of this embodiment is a female connector connected to a coaxial cable 3 that transmits a high-frequency signal or the like. The mating connector 2 (see FIG. 3) is a male connector mounted on a circuit board 4, and is also called a printed circuit board connector (PCB connector). Each of the connector 1 and the mating connector 2 has a shielding function for preventing leakage of electromagnetic waves and entry of electromagnetic waves from an outside caused by a signal transmitted by the coaxial cable 3.

Hereinafter, for convenience of description, as shown in FIGS. 1 to 6B, a “front-rear direction”, a “width direction”, an “upper-lower direction”, “upper”, and “lower” are defined. The “front-rear direction”, the “width direction”, and the “upper-lower direction” are orthogonal to one another. The front-rear direction coincides with a fitting direction of the connector 1 and the mating connector 2. For each of the connector 1 and the mating connector 2, a front face side in a fitting direction in which a mating connector is fitted is referred to as a front side, and a rear face side in a fitting direction opposite to the front side is referred to as a rear side.

When the female housing 5 and the male housing 12 are fitted to each other, the female housing 5 and the male housing 12 reach a state where the female housing 5 and the male housing 12 are completely fitted to each other (see FIG. 4B) through a state where the female housing 5 and the male housing 12 are being fitted to each other (see FIG. 4A). Hereinafter, for convenience of description, the former state is referred to as an “incompletely fitted state”, and the latter state is referred to as a “completely fitted state”.

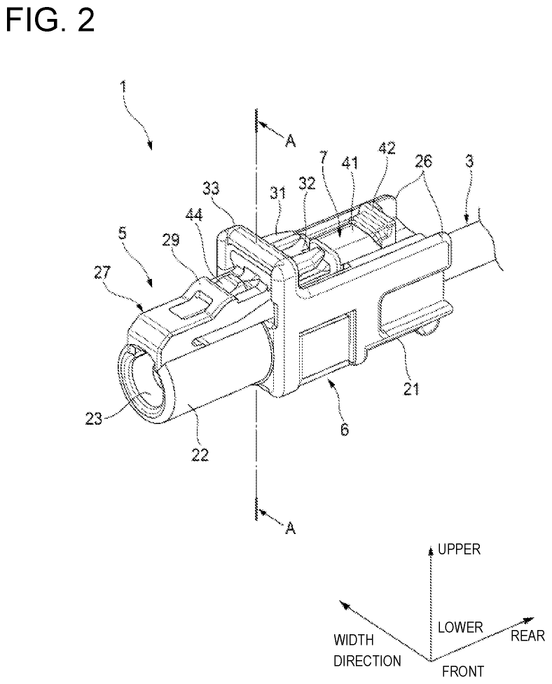

First, the connector 1 will be described with reference to FIGS. 1, 2, 4A and 4B. As shown in FIG. 2, the connector 1 includes the female housing 5, a spacer 6 mounted on a lower portion of the female housing 5, and a fitting-ensuring component 7 provided on an upper portion of the female housing 5 so as to be movable in the front-rear direction. Hereinafter, a configuration of each component that constitutes the connector 1 will be described in order. In the following description, the “fitting-ensuring component” is abbreviated as “CPA”.

First, the female housing 5 will be described. As shown in FIG. 2, the resin-made female housing 5 integrally includes a rectangular tube portion 21 having a substantially rectangular tube shape and a cylindrical portion 22 having a cylindrical shape. The cylindrical portion 22 is positioned on a front side of the rectangular tube portion 21, and has a shape that extends in the front-rear direction. The cylindrical portion 22 of the female housing 5 is inserted into a fitting recess 51 of the male housing 12 (see FIG. 3) of the mating connector 2, so that the female housing 5 and the male housing 12 are fitted to each other (see FIG. 4B).

As shown in FIGS. 2, 4A and 4B, a terminal housing chamber 23 that penetrates in the front-rear direction is formed inside the female housing 5 so as to extend in the front-rear direction. A female outer terminal 8 (see FIGS. 4A and 4B) and the like described later are housed in the terminal housing chamber 23. When the female housing 5 and the male housing 12 are fitted to each other, a male outer terminal 14 and the like, which will be described later, housed in the male housing 12 are inserted into a front end portion of the terminal housing chamber 23 (see FIGS. 4A and 4B).

As shown in FIGS. 2, 4A and 4B, an opening 24 is formed in the lower portion of the female housing 5 (more specifically, the rectangular tube portion 21). The opening 24 allows the terminal housing chamber 23 and an external space to communicate with each other in the upper-lower direction. The opening 24 is closed when the spacer 6 described later is mounted on the female housing 5. In the female housing 5, a cantilever-shaped lance 25 that extends forward so as to be elastically deformable in the upper-lower direction is formed so as to face an inside of the terminal housing chamber 23 from a lower side. A tip end (front end) of the lance 25 defines a rear side edge of the opening 24.

The lance 25 enters an opening 8a (see FIG. 4A) of the female outer terminal 8 inserted into the terminal housing chamber 23 from a rear side to lock a front side edge of the opening 8a, so that a function of preventing the female outer terminal 8 from coming off to a rear side is exerted. When the female outer terminal 8 is in a proper insertion position in the terminal housing chamber 23, the lance 25 enters the opening 8a of the female outer terminal 8, so that the lance 25 is maintained in a proper posture (that is, a posture shown in FIGS. 4A and 4B) in which the lance 25 is not elastically deformed. On the other hand, when the female outer terminal 8 is in a halfway inserted position, the lance 25 is maintained in a posture elastically deformed downward due to a fact that the lance 25 cannot enter the opening 8a of the female outer terminal 8.

As shown in FIG. 2, a pair of ribs 26 that rise upward are integrally provided at both end portions of an upper wall of the female housing 5 (more specifically, the rectangular tube portion 21) in the width direction so as to extend over an entire region of the rectangular tube portion 21 in the front-rear direction and so as to face each other in the width direction. A space sandwiched by the pair of ribs 26 functions as a space (so-called slide space) for housing a CPA 7 and guiding the CPA 7 in the front-rear direction. The pair of ribs 26 function to guide the CPA 7, which moves in the front-rear direction on the upper wall of the rectangular tube portion 21, in the front-rear direction. The rib 26 corresponds to a “guide wall” in the present disclosure.

As shown in FIG. 2, a lock portion 27 is provided at the upper portion of the female housing 5 (more specifically, the cylindrical portion 22). The lock portion 27 has a function of being switchable between maintaining and releasing the completely fitted state between the female housing 5 and the male housing 12 by engaging with a locked portion 54 (see FIGS. 3, 4A and 4B) described later of the male housing 12 of the mating connector 2.

As shown in FIG. 2, the lock portion 27 includes a pair of lock arms 28 that extend rearward in a cantilever shape at an interval in the width direction from a front end portion of an upper portion of the cylindrical portion 22 of the female housing 5. The pair of lock arms 28 are elastically deformable in the upper-lower direction and extend to a position above a front end portion of the upper wall of the rectangular tube portion 21 of the female housing 5.

The pair of lock arms 28 are integrally formed with a lock protrusion 29 that couples intermediate portions of the pair of lock arms 28 in the front-rear direction in the width direction, and an operation portion 31 that couples tip end portions (rear end portions) of the pair of lock arms 28 in the width direction. The operation portion 31 is positioned above the front end portion of the upper wall of the rectangular tube portion 21. A dimension of the operation portion 31 in the width direction is smaller than an interval between the pair of ribs 26 in the width direction. Therefore, the operation portion 31 can enter a space sandwiched by the pair of ribs 26 by being pushed downward. A recessed slit 32 that opens in a rear direction and the upper-lower direction and is recessed forward is formed in a widthwise central portion of a front end surface (rear end surface) of the operation portion 31. Functions because of the formation of the slit 32 will be described later. The slit 32 corresponds to a “recess” of the present disclosure.

When the locked portion 54 of the male housing 12 is engaged with the lock protrusion 29 of the lock portion 27, the completely fitted state between the female housing 5 and the male housing 12 is maintained (see FIG. 4B). In the completely fitted state, when the operation portion 31 is pushed downward into the space sandwiched by the pair of ribs 26, the lock protrusion 29 is moved downward and engagement between the lock protrusion 29 and the locked portion 54 is released, so that the female housing 5 and the male housing 12 can be separated from each other in the front-rear direction.

A coupling portion 33 that couples the pair of ribs 26 in the width direction so as to straddle a space above the operation portion 31 is integrally formed at a front end portion of the pair of ribs 26 (that is, a boundary portion between the rectangular tube portion 21 and the cylindrical portion 22). The coupling portion 33 functions to prevent the pair of lock arms 28 from being excessively deformed upward by interfering with the operation portion 31 when the pair of lock arms 28 are elastically deformed upward.

As shown in FIGS. 4A and 4B, in the terminal housing chamber 23 of the female housing 5, the substantially cylindrical metal-made female outer terminal 8 is inserted and housed from a rear side to the proper insertion position (see FIGS. 4A and 4B). A substantially cylindrical resin-made female inner housing 9 is housed in the female outer terminal 8. A cylindrical metal-made female inner terminal 11 is housed in the female inner housing 9. The female inner terminal 11 is connected to a front end portion of a core wire 3a of the coaxial cable 3 inserted into the terminal housing chamber 23 from a rear side, and the female outer terminal 8 is connected to a front end portion of a braided conductor 3b of the coaxial cable 3.

Next, the spacer 6 will be described. The resin-made spacer 6 shown in FIG. 2 has a shape corresponding to the opening 24 of the female housing 5, and is mounted on a lower portion of the female housing 5 so as to close the opening 24. As shown in FIGS. 4A and 4B, when the lance 25 is in a proper posture because the female outer terminal 8 is in the proper insertion position in the terminal housing chamber 23, the spacer 6 can be mounted on a proper position with respect to the female housing 5 without interfering with the lance 25.

Therefore, when the spacer 6 is mounted on the proper position, the spacer 6 functions to ensure that the female outer terminal 8 is in the proper insertion position. Further, in a state where the spacer 6 is mounted on the proper position, a part of the spacer 6 is engaged with the female outer terminal 8, so that the spacer 6 also functions to lock the female outer terminal 8 together with the lance 25 (so-called double locking function). Furthermore, the spacer 6 is disposed adjacent to a lower side of the lance 25, so that the lance 25 cannot be elastically deformed downward. Accordingly, the spacer 6 also functions to prevent engagement between the lance 25 and the opening 8a of the female outer terminal 8 from being released due to downward elastic deformation of the lance 25.

On the other hand, when the lance 25 is in a downwardly deformed posture because the female outer terminal 8 is in the halfway inserted position in the terminal housing chamber 23, the spacer 6 interferes with the lance 25 and cannot be mounted on the proper position with respect to the female housing 5. In this way, since the spacer 6 cannot be mounted on the proper position, the halfway insertion of the female outer terminal 8 can be easily detected.

Next, the CPA 7 will be described. The resin-made CPA 7 shown in FIG. 2 is provided on the upper wall of the rectangular tube portion 21 of the female housing 5 so as to be movable in the front-rear direction. The CPA 7 includes a substantially rectangular parallelepiped main body portion 41 that extends in the front-rear direction. A CPA operation portion 42 that protrudes upward and extends in the width direction is provided at a rear upper portion of the main body portion 41. A dimension of the main body portion 41 in the width direction is smaller than the interval between the pair of ribs 26 in the width direction. Therefore, the main body portion 41 is movable in the front-rear direction in the space sandwiched by the pair of ribs 26 while being guided by the pair of ribs 26.

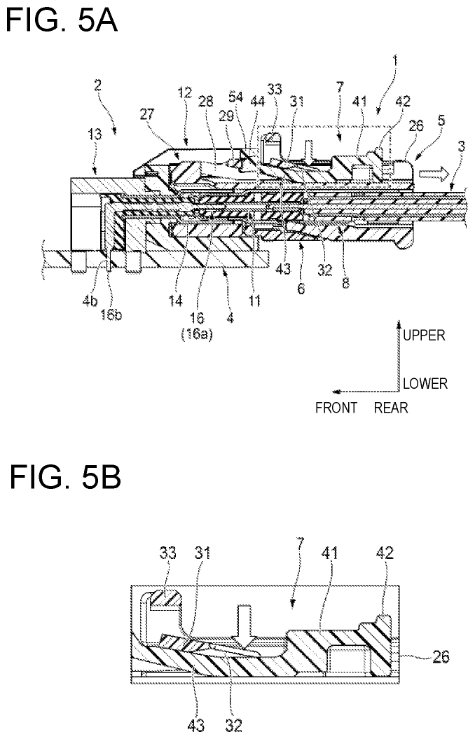

The main body portion 41 is integrally formed with an arm portion 43 that extends forward from a widthwise central portion of a lower portion of a front surface of the main body portion 41. A protrusion 44 to be engaged with the lock protrusion 29 of the lock portion 27 is formed at a tip end portion (that is, a front end portion) of the arm portion 43 so as to protrude upward. A dimension of the arm portion 43 in the width direction is smaller than the dimension of the main body portion 41 in the width direction. An upper end surface of a root portion of the arm portion 43 is positioned below an upper end surface of the main body portion 41. Further, the dimension of the arm portion 43 in the width direction is smaller than a dimension of the slit 32 in the width direction, in which the slit 32 is formed in the operation portion 31 of the lock portion 27. Therefore, when the operation portion 31 is pushed downward (when the lock arms 28 are elastically deformed downward), a part of the arm portion 43 in the front-rear direction can enter an inside of the slit 32 (see FIGS. 5A and 5B described later). Functions resulting therefrom will be described later. The arm portion 43 corresponds to a “part of the fitting-ensuring component” in the present disclosure. In a state before the connector 1 and the mating connector 2 are fitted to each other (a state of the connector 1 alone), the CPA 7 is locked at an initial position shown in FIG. 4A on the upper wall of the rectangular tube portion 21 of the female housing 5. In order to lock the CPA 7 at the initial position, (the main body portion 41 of) the CPA 7 is housed in the space sandwiched by the pair of guide walls 26 of the female housing 5 from a rear side, and the CPA 7 is moved forward by pressing the CPA operation portion 42 forward while being guided by the pair of guide walls 26.

Such forward movement of the CPA 7 is continued until the protrusion 44 positioned at the tip end of the arm portion 43 of the CPA 7 is engaged with a rear surface of the lock protrusion 29 of the lock portion 27 of the female housing 5. When the protrusion 44 of the CPA 7 is engaged with the rear surface of the lock protrusion 29 of the female housing 5, the CPA 7 is locked at the initial position with respect to the female housing 5 (see FIG. 4A). In a state where the CPA 7 is locked at the initial position, the CPA 7 cannot move further forward. Therefore, the CPA 7 cannot move from the initial position to a fitting-ensuring position (see FIG. 4B), which will be described later, in front of the initial position. The connector 1 has been described above.

Next, the mating connector 2 will be described with reference to FIGS. 3, 4A and 4B. As shown in FIG. 3, the mating connector 2 includes the male housing 12. The resin-made male housing 12 has a shape that extends in the front-rear direction, and the fitting recess 51 that opens forward and upward and is recessed rearward is formed inside the male housing 12. The cylindrical portion 22 of the female housing 5 is fitted with the fitting recess 51 from a front side. A substantially rectangular box-shaped aluminum die-cast made frame body 13 is assembled to a rear wall portion 52 (see FIGS. 4A and 4B) of the male housing 12 that constitutes a bottom wall (rear wall) of the fitting recess 51 so as to be disposed on a rear side of the male housing 12.

As shown in FIG. 4A, a plurality of leg portions 13a that extend downward are provided at a lower end portion of the frame body 13. The plurality of leg portions 13a are inserted into and fixed to a plurality of through holes 4a provided in the circuit board 4. Accordingly, the frame body 13 (and the male housing 12 positioned on a front side of the frame body 13) is fixed to an upper surface of the circuit board 4.

As shown in FIG. 4A, a terminal housing hole 53 that penetrates in the front-rear direction is formed in the rear wall portion 52 of the male housing 12. The substantially cylindrical metal-made male outer terminal 14 is inserted into and fixed to the terminal housing hole 53 from a front side. A front end portion of the male outer terminal 14 is positioned inside the fitting recess 51. A rear end portion of the male outer terminal 14 is connected to the frame body 13. Accordingly, the male outer terminal 14 is electrically connected to an earth portion (grounding portion, not shown) of the circuit board 4 via the frame body 13.

As shown in FIG. 4A, a substantially cylindrical resin-made male inner housing 15 is housed in the male outer terminal 14. A rod-shaped tab portion 16a that extends in a front-rear direction of an L-shaped metal-made male inner terminal 16 is housed in the male inner housing 15. A tip end portion (front end portion) of the tab portion 16a is positioned inside the front end portion of the male outer terminal 14. A rod-shaped hanging portion 16b that extends downward from a rear end portion of the tab portion 16a of the male inner terminal 16 is inserted into and fixed to a through hole 4b provided in the circuit board 4. Accordingly, the male inner terminal 16 is electrically connected to a communication circuit (not shown) of the circuit board 4. Further, the male inner terminal 16 (particularly, the hanging portion 16b) is covered by the frame body 13.

As shown in FIGS. 3, 4A and 4B, the locked portion 54 that extends in the width direction is provided at an upper portion of a front end portion of the male housing 12. When the female housing 5 and the male housing 12 are fitted to each other, the lock protrusion 29 of the lock portion 27 of the female housing 5 is engaged with the locked portion 54 (see FIG. 4B). The mating connector 2 has been described above.

Next, a fitting operation between the connector 1 and the mating connector 2 will be described. As shown in FIGS. 4A and 4B, the connector 1, which is connected to the coaxial cable 3 and where the CPA 7 is locked in the initial position, is fitted with the mating connector 2 mounted on the circuit board 4. The fitting work is performed such that (the cylindrical portion 22 of) the female housing 5 is inserted into the fitting recess 51 of the male housing 12, a front end portion of the female outer terminal 8 is inserted into the front end portion of the male outer terminal 14, and a front end portion of the male inner terminal 16 (tab portion 16a) is inserted into a front end portion of the female inner terminal 11 (see FIG. 4A). The fitting work is continued until the locked portion 54 of the male housing 12 is engaged with the lock protrusion 29 of the lock portion 27 of the female housing 5.

The locked portion 54 climbs over an upper portion of the lock protrusion 29 of the lock portion 27 temporarily elastically deformed downward by pressing from the locked portion 54, and moves to an elastically returned rear side of the lock protrusion 29 of the lock portion 27, so that the locked portion 54 and the lock protrusion 29 are engaged with each other (see FIG. 4B). Accordingly, the female housing 5 and the male housing 12 are maintained in the completely fitted state.

Further, when the locked portion 54 is moved to the rear side of the lock protrusion 29, the locked portion 54 pushes down the protrusion 44 of the CPA 7 positioned on the rear side of the lock protrusion 29, so that the arm portion 43 of the CPA 7 is elastically deformed downward, and engagement between the protrusion 44 and the lock protrusion 29 is released. That is, the CPA 7 can be moved from the initial position to the fitting-ensuring position (see FIG. 4B) in front of the initial position. Then, when the female housing 5 and the male housing 12 are in the completely fitted state, (the CPA operation portion 42 of) the CPA 7 at the initial position is pushed forward, so that the CPA 7 is moved to the fitting-ensuring position as shown in FIG. 4B while maintaining a state where the arm portion 43 is elastically deformed downward. When the CPA 7 reaches the fitting-ensuring position, the protrusion 44 climbs over a lower portion of the lock protrusion 29 and the arm portion 43 elastically returns, so that the protrusion 44 is moved to a front side of the lock protrusion 29. Accordingly, the CPA 7 is locked in the fitting-ensuring position. The fitting-ensuring position corresponds to a “mounting position” of the present disclosure.

In this way, since the CPA 7 is in the fitting-ensuring position, the CPA 7 functions to ensure that the female housing 5 and the male housing 12 are in the completely fitted state. Further, in a state where the CPA 7 is in the fitting-ensuring position, as shown in FIG. 4B, a front upper corner portion of the main body portion 41 is disposed adjacent to a lower side of the operation portion 31 of the lock portion 27, so that the operation portion 31 cannot move downward. Accordingly, the CPA 7 also functions to prevent release of engagement between the lock protrusion 29 and the locked portion 54 (the so-called double locking function) caused by downward elastic deformation of the lock portion 27.

On the other hand, when the female housing 5 and the male housing 12 are in the incompletely fitted state, the locked portion 54 of the male housing 12 does not press the protrusion 44 of the CPA 7 downward, so that engagement between the protrusion 44 and the lock protrusion 29 is not released. Therefore, the CPA 7 cannot move from the initial position to the fitting-ensuring position. In this way, since the CPA 7 cannot move from the initial position to the fitting-ensuring position, the incompletely fitted state between the female housing 5 and the male housing 12 can be easily detected. The fitting operation of the connector 1 and the mating connector 2 has been described above.

In the completely fitted state between the female housing 5 and the male housing 12, the male inner terminal 16 and the female inner terminal 11 are electrically connected to each other (see FIG. 4B). Accordingly, a high-frequency signal transmitted by the coaxial cable 3 is transmitted to the communication circuit (not shown) of the circuit board 4 via the male inner terminal 16. Further, the female outer terminal 8 and the male outer terminal 14 are electrically connected to each other. Accordingly, a minute current generated by the female outer terminal 8 collecting electromagnetic waves is grounded to the earth portion of the circuit board 4 via the male outer terminal 14 and the frame body 13. That is, an electromagnetic shield circuit is formed.

Next, an operation when the female housing 5 and the male housing 12 are separated from each other from the state shown in FIG. 4B (the state where the female housing 5 and the male housing 12 are in the completely fitted state and the CPA 7 is in the fitting-ensuring position) for maintenance or the like will be described.

In order to separate the female housing 5 and the male housing 12 from each other, first, the CPA operation portion 42 of the CPA 7 is pulled rearward to return the CPA 7 from the fitting-ensuring position to the initial position. Next, as shown in FIG. 5A, the operation portion 31 of the lock portion 27 is pushed downward into the space defined between the pair of ribs 26. Accordingly, the lock protrusion 29 of the lock portion 27 elastically deformed downward moves downward. As a result, engagement between the lock protrusion 29 and the locked portion 54 is released, and the female housing 5 and the male housing 12 can be separated from each other in the front-rear direction. Therefore, the female housing 5 and the male housing 12 can be separated from each other.

Here, in the present example, when the operation portion 31 is pushed downward (when the lock arms 28 are elastically deformed downward), as shown in FIG. 5B, a part of the arm portion 43 in the front-rear direction enters an inside of the slit 32. In other words, the arm portion 43 and the operation portion 31 have an overlapping structure that avoids interference with each other. Therefore, as compared with a mode in which the slit 32 is not formed, a lowermost position within a movable range of the operation portion 31 in the upper-lower direction can be set to be lower by an amount by which a part of the arm portion 43 enters the slit 32. That is, such an overlapping structure expands the movable range of the operation portion 31.

Specifically, in the present example, as shown in FIG. 5B, a part of the arm portion 43 enters the slit 32, so that the operation portion 31 can move downward until a lower surface (bottom surface) of the operation portion 31 is in surface contact with an upper surface of the arm portion 43. That is, a position of the operation portion 31 in a state where the lower surface of the operation portion 31 is in surface contact with the upper surface of the arm portion 43 is the lowermost position of the operation portion 31. On the contrary, in the mode in which the slit 32 is not formed, when the operation portion 31 is pushed downward, a tip end (rear end) of the operation portion 31 is in contact with the upper surface of the arm portion 43 before the lower surface of the operation portion 31 is in surface contact with the upper surface of the arm portion 43. Therefore, a position of the operation portion 31 in a state where the tip end of the operation portion 31 is in contact with the upper surface of the arm portion 43 (that is, the position above the lowermost position of the operation portion 31 in the present example) is the lowermost position of the operation portion 31.

In this way, in the present example, the position of the operation portion 31 in a non-elastically deformed state of the lock portion 27 can be set to be lower by an amount by which the lowermost position of the operation portion 31 can be set to be lower than that in the mode in which the slit 32 is not formed, while securing a downward deflection amount of the lock portion 27 (that is, a downward movement amount of the operation portion 31) necessary for releasing engagement between the lock protrusion 29 and the locked portion 54. As a result, in the present example, the connector 1 can be miniaturized particularly in the upper-lower direction as compared with the mode in which the slit 32 is not formed.

<Functions and Effects>

As described above, according to the connector 1 of the present embodiment, when the lock portion 27 is operated so as to release fitting between the female housing 5 and the male housing 12, a part of the CPA 7 enters the slit 32 of the lock portion 27, so that mutual interference is avoided. Therefore, even when a large deflection space is not provided as in the related-art connector described above, the lock portion 27 can be displaced in a releasing direction (in a direction approaching the fitting-ensuring component). Therefore, the connector 1 according to the present embodiment can be miniaturized as compared with the related-art connector.

Further, according to the connector 1 of the present embodiment, the lock portion 27 includes the slit 32, and the lock arms 28 can be deflected such that a part of the CPA 7 enters the slit 32 when fitting is released. Accordingly, the CPA 7 and the lock arms 28 overlap (that is, overlap) each other by an amount by which the slit 32 enters a part of the CPA 7. Therefore, the connector 1 according to the present embodiment can be miniaturized by the overlapping amount as compared with the related-art connector. Further, a guide effect of the lock arms 28 can also be obtained by the CPA 7 entering the slit 32.

### Other Embodiments

The present disclosure is not limited to the above embodiments and may adopt various modifications within the scope thereof. For example, the present disclosure is not limited to the above-described embodiments, and can be modified, improved, and the like as appropriate. In addition, materials, shapes, dimensions, numbers, arrangement locations, and the like of elements in the above-described embodiments are optional and not limited as long as the object of the present disclosure can be achieved.

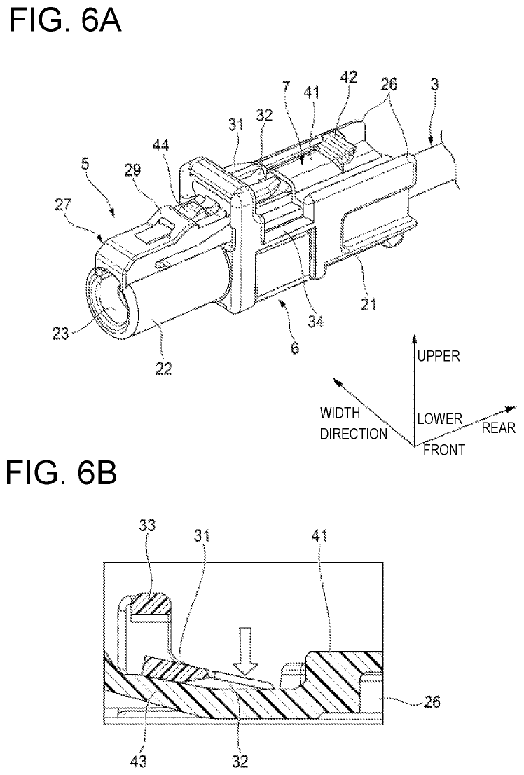

In the above embodiment, the pair of ribs 26 are provided on an upper wall of the female housing 5 so as to extend over the entire region of the rectangular tube portion 21 in the front-rear direction (see FIG. 1). On the contrary, as shown in FIG. 6A, the pair of ribs 26 may be provided so as to extend over a range of the rectangular tube portion 21 in a front-rear direction excluding a range in the front-rear direction corresponding to the operation portion 31 of the lock portion 27 (that is, a front end portion of the rectangular tube portion 21), and recesses 34 recessed downward may be formed at both end portions of an upper wall of the front end portion of the rectangular tube portion 21 in a width direction. In this way, since the recesses 34 are formed in the range in the front-rear direction corresponding to the operation portion 31 of the lock portion 27, the ribs 26 are unlikely to hinder work of pushing down the operation portion 31 with a finger. Further, the ribs 26 facilitate work of moving the CPA 7 in the front-rear direction.

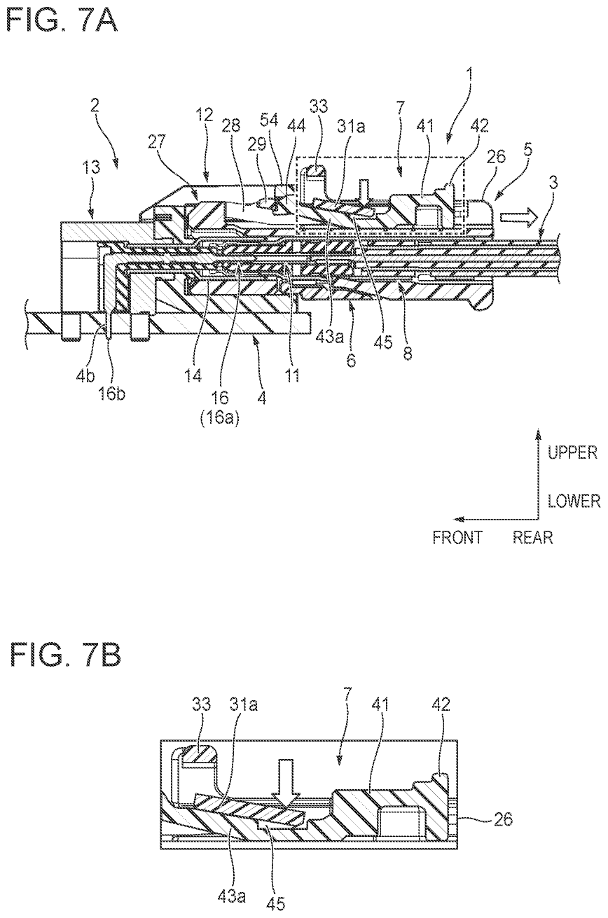

Further, in the above embodiment, a part of the arm portion 43 of the CPA 7 enters the slit 32 provided in the operation portion 31 of the lock portion 27, so that the mutual interference is avoided. Alternatively, as illustrated in FIGS. 7A and 7B, a recess 45 recessed downward may be formed in an upper surface of a part of an arm portion 43a of the CPA 7, and a tip end (rear end) of an operation portion 31a of the lock portion 27 may enter the recess 45, so that mutual interference may be avoided. That is, at least a part of the other of the lock portion 27 and the CPA 7 may be configured to enter the recess of one of the lock portion 27 and the CPA 7.

Here, characteristics of the embodiments of the connector 1 according to the present disclosure described above will be briefly summarized and listed in [1] to [3] below.

[1] A connector (1) including:

a housing (5) including a lock portion (27) configured to be engaged with a mating housing (12) when the housing (5) is fitted with the mating housing (12); and

a fitting-ensuring component (7) mounted on the housing (5) and configured to detect whether the housing (5) and the mating housing (12) are fitted with each other by avoiding interference with the lock portion (27) and being movable to a predetermined mounting position when the housing (5) and the mating housing (12) are fitted with each other,

in which the lock portion (27) and the fitting-ensuring component (7) are configured that at least a part of one of the lock portion (27) and the fitting-ensuring component (7) enters a recess (32) of the other of the lock portion (27) and the fitting-ensuring component (7) so as to extend a movable range of the lock portion (27) when the lock portion (27) is operated so as to release engagement between the lock portion (27) and the mating housing (12).

[2] The connector (1) according to the above [1],

in which the lock portion (27) includes a cantilever-shaped lock arm (28) that extends so as to overlap at least a part of the fitting-ensuring component (7); and

in which the lock arm (28) has the recess (32) into which the at least a part of the fitting-ensuring component (7) enters when the lock arm (28) is deflected in an approaching direction approaching the fitting-ensuring component (7) so as to release engagement with the mating housing (12).

[3] The connector (1) according to the above [2],

in which the lock portion (27) includes an operation portion (31) to which an external force for deflecting the lock arm (28) in the approaching direction is applied; and

in which the housing (5) includes a guide wall (26) that guides the fitting-ensuring component (7) to the predetermined mounting position at a predetermined location excluding a vicinity of the operation portion (31).

According to the connector having the configuration of the above [1], when the lock portion is operated to release engagement between the lock portion and the mating housing, at least a part of the other of the lock portion and the fitting-ensuring component (CPA) enters a recess (for example, a slit-shaped recess) of one of the lock portion and the fitting-ensuring component (CPA), so that mutual interference is avoided. That is, the lock portion and the fitting-ensuring component have an overlapping structure for avoiding interference. Therefore, since a movable range of the lock portion is widened by an overlapping amount of the two, even when a deflection space is narrowed as compared with the related-art connector described above, a movement amount of the lock portion necessary for releasing the engagement can be secured. Therefore, the connector having the configuration can be miniaturized as compared with the related-art connector while maintaining a function as a connector with the fitting-ensuring component (CPA).

According to the connector having the configuration of the above [2], the lock portion (that is, the lock arm) includes the recess, and when the engagement is released, the lock arm can be deflected while at least a part of the fitting-ensuring component (CPA) enters the recess. That is, the lock portion and the fitting-ensuring component are overlapped with each other. Therefore, the connector having the configuration can be miniaturized as compared with the related-art connector by the overlapping amount. Further, as another effect, in the connector having the configuration, at least a part of the fitting-ensuring component enters the recess, so that an effect of regulating a deflection direction such that the lock arm is deflected in a designed direction is also obtained.

According to the connector having the configuration of the above [3], a guide wall that guides a movement of the fitting-ensuring component is provided so as to avoid a vicinity of the operation portion of the lock arm. Therefore, for example, when the operation portion of the lock arm works by pushing the operation portion of the lock arm by a finger, a jig, or the like of a worker, the guide wall is unlikely to interfere with the finger or the like, and such work is unlikely to be hindered. Further, work of moving the fitting-ensuring component toward the mounting position is facilitated by the guide wall. Therefore, the connector having the configuration can improve workability of both work of fitting detection and work of fitting release.

What is claimed is:

1. A connector comprising:
a housing comprising a lock portion configured to be engaged with a mating housing when the housing is fitted with the mating housing; and
a fitting-ensuring component mounted on the housing and configured to detect whether the housing and the mating housing are fitted with each other by avoiding interference with the lock portion and being movable to a predetermined mounting position when the housing and the mating housing are fitted with each other,
wherein the lock portion and the fitting-ensuring component are configured that at least a part of one of the lock portion and the fitting-ensuring component enters a recess of the other of the lock portion and the fitting-ensuring component so as to extend a movable range of the lock portion when the lock portion is operated so as to release engagement between the lock portion and the mating housing.

2. The connector according to claim 1,
wherein the lock portion comprises a cantilever-shaped lock arm that extends so as to overlap at least a part of the fitting-ensuring component; and
wherein the lock arm has the recess into which the at least a part of the fitting-ensuring component enters when the lock arm is deflected in an approaching direction approaching the fitting-ensuring component so as to release engagement with the mating housing.

3. The connector according to claim 2,
wherein the lock portion comprises an operation portion to which an external force for deflecting the lock arm in the approaching direction is applied; and
wherein the housing comprises a guide wall that guides the fitting-ensuring component to the predetermined mounting position at a predetermined location excluding a vicinity of the operation portion.
